(19) United States
(12) Patent Application Publication
(10) Pub. No.: US 2002/0198641 A1
(43) Pub. Date: Dec. 26, 2002

(54) Mobile system for recording aggressive driving

(76) Inventor: Brian S. Halle, Fairfax, VA (US)

Correspondence Address: Brian S. Halle, 9308 Silvermill Place, Fairfax, VA, 22031, US

(21) Appl. No.: 10/223,338

(22) Filed: Aug. 19, 2002

(51) Int. Cl. G06F 19/00

(52) U.S. Cl. 701/35; 701/70; 701/213

(57) ABSTRACT

System for automated electronic recording of motor vehicles that follow other motor vehicles too closely at high speeds. The system is a connection in the host vehicle of the speedometer, GPS, a wireless communications device, a motion sensor, and a camera for electronic photography, such as a digital camera. The system records the speed, location, date, time, and the license plates of the motor vehicle that is following too closely. Electronic data files are transferred from the host vehicle to a data center with access to ownership registration data on motor vehicles. The data center develops an electronic file on ownership information on the photographed vehicle and then forwards all the data files to the local jurisdiction where the incident took place. Alternatively, the data center forwards the data files to a government contractor that processes traffic tickets and collects traffic fines for that jurisdiction.

### CROSS REFERENCES TO RELATED APPLICATIONS

Not applicable. No benefits are claimed from prior applications.

OTHER REFERENCES
U.S. Patent Documents

| | | | |
|---|---|---|---|
| 5983161 | November 1999 | Lemelson et al. | 701/301 |
| 6226389 | May 2001 | Lemelson et al. | 382/104 |
| 6246933 | June 2001 | Bague | 701/35 |
| 6275773 | August 2001 | Lemelson et al. | 701/301 |
| 6279946 | August 2001 | Johnson et al. | 280/735 |
| 6314364 | November 2001 | Nakamura | 701/200 |
| 6317058 | November 2001 | Lemelson et al | 340/910 |
| 6370475 | April 2002 | Breed et al | 701/301 |
| 6401027 | June 2002 | Xu et al. | 701/117 |
| 6405132 | June 2002 | Breed, et al | 703/301 |

In August 2002, the Ford Motor Company announced test models of sensors in a motor vehicle's middle brake light that detect vehicles in the rear before a collision occurs. This system, however, makes no attempt to use digital cameras to photograph other vehicles when they get too close, let alone for the purposes of assisting law enforcement.

### DESCRIPTION

### BACKGROUND OF THE INVENTION

1. Review

At present, automotive safety technology tends to focus on reducing the effects of motor vehicle accidents rather than providing a deterrent against hazardous driving that causes some of these accidents. Yet, over six million motor vehicle accidents are reported annually. This has resulted in the following trends found by the U.S. Department of Transportation.

In 1994, the economic cost of motor vehicle accidents was estimated to exceed $150 billion. For six years, annual deaths from car crashes have not fallen below 40,000. In 1998, motor vehicle crashes were the leading cause of death for Americans between the ages of four and thirty-three. In 2000 alone, injuries and deaths from these accidents were three times greater than total American casualties reported during all of World War II.

In that year, 41,821 people were reported killed and 3.2 million were reported injured in over 6.4 million crashes reported among 190 million licensed drivers. On average, there were over 17,000 motor vehicle accidents, almost 9,000 casualties, and over 100 deaths reported every day. Accordingly, the probability that a high school student today will have a reported car accident as an adult is almost 85%. And unreported accidents may exceed reported accidents.

For comparison, if only ten percent of motor vehicle collisions are caused by aggressive drivers who tail-gate at high speeds, then it's possible that each year these drivers are killing more civilians than were lost from terrorist attacks on Sep. 11, 2001.

Steel bars, plastic belts, and cloth air bags can reduce and even prevent direct injuries after a car has been hit. But these products can do nothing to stop an accident before it happens.

But current technology, including the Internet, can be combined to offer an electronic deterrent against aggressive drivers who tail-gate. By using products that are already available today, drivers can get a new level of protection for America's most costly battleground: its own streets and highways.

2. Fields of Endeavor

This invention is in the fields of automotive safety, aggressive driving, collision avoidance, collision detection, digital photography, computer video monitoring, automotive navigation, law enforcement, wireless telecommunications, and Internet applications.

### SUMMARY OF THE INVENTION

The invention is a system for automated electronic recording of tail-gating at high speeds from motor vehicles that are being followed too closely.

This invention supports the transfer of this recorded data in electronic files to local jurisdictions or privately-held companies with government contracts to assist these jurisdictions in processing traffic tickets and collecting traffic fines.

### DETAILED DESCRIPTION OF THE INVENTION

The invention is a system that creates electronic data files with information on aggressive drivers who follow other cars too closely at high speeds. These data files can be transferred and used for processing traffic tickets and fines by local governments. This system is based on automated cameras fixed at traffic lights that have recorded red light violations in the United States for over five years and in Europe for over twenty-five years. The same system for processing traffic tickets and collecting fines from red light violations can also be adapted for the system of this invention.

The system is the connection in motor vehicles of the following products: speedometers, motion sensors, global positioning satellite technology receivers (GPS), speedometers, wireless telecommunications devices, and cameras that can record photographs electronically, such as digital cameras or PC cameras.

The sensor and camera are placed in the rear of the vehicle, preferably at the top of the middle of the rear windshield. When the sensor and the speedometer indicate that another motor vehicle is tail-gating continuously at high speeds, then the camera photographs its license plates and this information is recorded in an electronic data file.

The camera takes several photographs in a few seconds. In addition, until the motor vehicle that is tail-gating moves farther behind, it is photographed repeatedly, and the additional information is also recorded repeatedly in more data files.

The sensor and camera are connected electronically or electrically to the vehicle's speedometer, its GPS receiver, and a wireless telecommunications device, such as a wireless telephone with Internet access. From prompts from the motion sensor or the camera, additional information on the date, time, location, and the speed of the incident is recorded in additional electronic data files while the camera photographs the license plates of the motor vehicle that is following too closely.

Through the vehicle's wireless telecommunications device, all the data files are transferred to a data center. For example, such data files could be transferred to the data center as attachments to an electronic mail message from a wireless telephone with Internet access. The data center has confidential access to databases maintained by the states on motor vehicle registrations. After scanning the license plates in the photograph, the data center obtains vehicle registration data and adds this information to another data file. All the data files are then sent from the data center to the local jurisdiction where the incident occurred. Alternatively, the data center can send the files to government contractors who are now processing traffic violations on behalf of local jurisdictions. After the data files are reviewed and the information is compiled, traffic tickets and payment forms may be mailed to the vehicle's registered owner along with copies of the information provided from the electronic data files. Or the information may be rejected for purposes of law enforcement if it contains errors or incomplete material.

At this time, individuals who receive these traffic tickets in the mail have the right to contest the violations in court. If they decline to contest the traffic tickets, the owners of the motor vehicles can pay the fines by mail.

What is claimed is:

1. A electronic system for recording motor vehicles that follow all types of other motor vehicles too closely at high speeds.

2. The system claimed in claim 1 is the electronic and/or electrical connection of the following:
the speedometer in a motor vehicle,
a motion sensor placed in the rear of said vehicle,
a camera placed in the rear of said vehicle that can record photographs electronically,
a global positioning satellite (GPS) receiver placed in said vehicle,
a wireless telecommunications device that can be placed in said motor vehicle or carried by hand into said vehicle,
a data center that can receive electronic data files through wireless telecommunications and that can access data bases with ownership registration information on motor vehicles.
